(19) United States
(12) Patent Application Publication
(10) Pub. No.: US 2001/0032098 A1
(43) Pub. Date: Oct. 18, 2001

(54) Internet ready medical device

(76) Inventor: Avi Kulkarni, Livingston, NJ (US)

Correspondence Address: GARDNER, CARTON & DOUGLAS, 321 N. CLARK STREET, SUITE 3400, CHICAGO, IL, 60610, US

(21) Appl. No.: 09/729,976

(22) Filed: Dec. 6, 2000

Related U.S. Application Data
(60) Provisional application No. 60/169,088, filed on Dec. 6, 1999.

(51) Int. Cl. G06F 17/60

(52) U.S. Cl. 705/2

(57) ABSTRACT

The present invention relates to a method and apparatus for acquiring data, particularly, data related to a person's healthcare habits, forwarding the data to a remote location where the data can be processed and allowing one to access the data from various other remote locations over the Internet or other network. The invention includes collecting data from various devices including dumb devices which have no electronics or computing power associated therewith, as well as collecting data from devices that have computing power and electronics. For example, a pillbox can be retrofitted with an electronic circuitry that records the opening and closing of the pillbox.

This application claims the benefit of U.S. Provisional Application No. 60/169,088, filed Dec. 6, 1999.

### FIELD OF THE INVENTION

The present invention relates to devices for acquiring medical data from individuals that can be transferred to a remote central server for accumulating and processing. More specifically, the present invention relates to Internet ready medical devices for collecting data relating to an individual's health and/or medical treatment regimen.

### BACKGROUND OF THE INVENTION

It is known to obtain patient information from individuals and to store the information in a database for facilitating monitoring of a patient's health and healthcare practices. Normally, this information is accumulated by performing tests. For example, physicians frequently perform stress tests on individuals that require attaching electrodes to an individual, interconnecting the electrodes with devices for acquiring the signals, processing the signals and providing a report. Such data acquisition devices tend to be obtrusive and limited in applicability to day to day life. Accordingly, while such obtrusive means provide important information about a patient, the information is limited to collection at specific times and at specific locations. While extended tests can be performed by wearing equipment around for hours or a day, such methods for accumulating information are cumbersome and limited in applicability. Further, such methods of acquiring data cannot be applied to “dumb” devices, i.e. devices without electronic circuitry and/or memory.

Similarly, information can be input into a computer concerning a person's healthcare practices for monitoring his or her healthcare over long periods of time. For example, an individual can record the medicine (such as pills, injections, etc.) and or other health related activities (such as time spent on a treadmill) that he or she takes or performs over the course of a day. However, in order to provide reliable data, the individual must make an effort to enter the data on a regular basis. Thereafter, this data must be further processed. This data collection effort often proves difficult for people to religiously track their habits, and thus, systems requiring people to perform tasks are not generally practicable.

Accordingly, it would be advantageous to have a method and system that passively collects data from an individual, from numerous sources, including from so-called “dumb” devices, and transmits data to a remote central server where the data can be collected, processed, analyzed and utilized by the appropriate healthcare providers. Additionally, it would be desirable to collect the requisite medical data without interfering with the person's lifestyle or requiring the person to make any particular effort or to perform any specific operation to capture the data.

### SUMMARY OF THE INVENTION

The present invention provides a method and apparatus for collecting healthcare information from an individual that does not require any special action by the person. The present invention acquires data relating to a person and forwards the data to a remote central location where it can be stored, processed and analyzed to provide information to the individual and/or to other involved in providing healthcare to that individual. In an embodiment, the present invention provides a method and apparatus for obtaining data about a person's healthcare habits by acquiring data from devices without electronic controls, programmable devices and smart devices. In another embodiment, the present invention incorporates electronic equipment into dumb devices to provide for the collection of data therefrom and allows for transmittal of the data via the Internet or other communications means to a remote location where it is processed and utilized.

The present invention includes collecting data from various devices including dumb devices that have no electronics or computing power associated therewith, as well as collecting data from devices that have computing power and electronics associated therewith. Means are provided for managing and tracking the data at the central location. The data can be accessed via the Internet or other communications means to provide feedback to the person, or the person's physician or any other interested party.

In a preferred embodiment, electronic circuitry is incorporated into a device such as a pillbox for recording events such as the opening and closing of the pillbox. This data captured by the electronic circuitry is sent, for example via the Internet to a remote central location where it can be processed. [In another embodiment, a device without electronic circuitry can be placed on a scale and weighed, a change in weight indicating that a pill was removed, and changes in weight recorded and exported to the central location. This information can then be utilized to track among other things, the individual's diligence in taking the medication.] Various other activities can be similarly tracked and monitored, for example, the amount of time a person spends on a treadmill, the amount of time spent watching television, etc.

In a further embodiment, the present invention provides a control box for use in acquiring data at an input and exporting the data at an output, which control box can be used by a dumb device, a programmable device and/or a smart device.

### BRIEF DESCRIPTION OF THE DRAWINGS

Other important objects and features of the invention will be apparent from the following detailed description of the invention taken in connection with the accompanying drawings in which:

FIG. 1 illustrates a preferred embodiment of the system of the present invention.

FIG. 2 is another embodiment of a pillbox modified according to the present invention.

FIG. 3 is an alternative embodiment of the present invention.

### DETAILED DESCRIPTION OF THE INVENTION

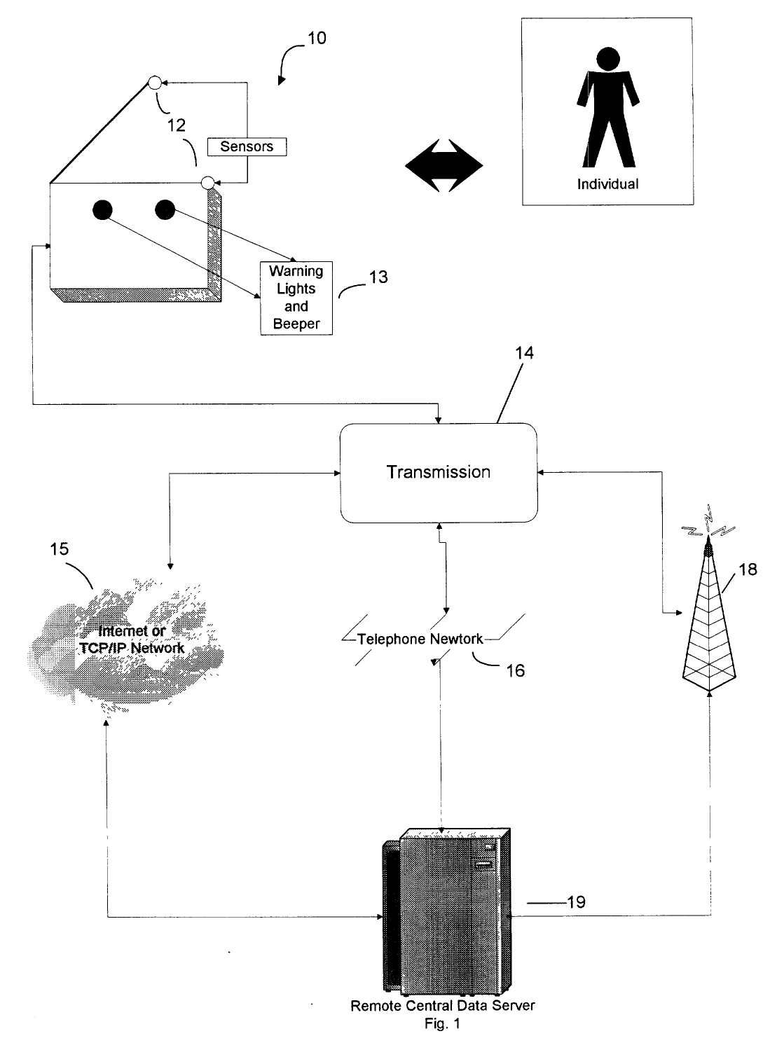

Referring to FIG. 1, one aspect of the present invention relates to a device (10) such as a pillbox (10) although a pillbox is illustrated, it should be understood that it is not intended to limit the invention to a particular form. A person using the pillbox (10) with no electronics simply takes the recommended pill dosage from the pillbox (10) and communicates this information to the remote central database (19) by means such as e-mail, telephonically, pager or similar method. Alternately, the pillbox (10) can include sensors (12) for the detection of the removal of medication from the pillbox (10). For example, contact sensors comprised of magnetic, capacitative or inductive type material can be utilized to detect opening of a specific pillbox compartment. When the pillbox (10) is opened, a circuit is opened or closed and the information signal is transmitted by transmission means (14) to the remote central data server (19). Therefore, a seemingly dumb device can become a smart pillbox by connecting it the Internet. Optionally, the pillbox can be further enhanced to track dispensing of pills. Weight sensors can be used to calculate the reduction in the weight of a compartment. Because the dosage is a known weight, when a pill is removed, the weight is decreased and is recorded and transmitted to the remote central data server (19). The quantity of dosage can be determined by weight changes. Other means using an electronic scale including manually weighing the pillbox (10) are included within the scope of this invention. Additionally, light sensors or IR sensors can be used to count the number of pills being dispensed from a compartment of the pillbox (10).

As shown in FIG. 1, the pillbox (10) communicates information real-time to the users of the pillbox (10) via colored LED's (13) with each color having a specific significance. For example, a red light can be used to alert the user that the medication to be taken is due or a green light can be used to suggest that the user has taken all the scheduled medications or a yellow light can be used to suggest that hardware or software has technical problems. In a further embodiment, pre-recorded voice prompts or specific beeps can be emitted by the pillbox (10) to alert a user.

The pillbox (10) can further include hardware such as a built-in microprocessor and software for establishing an Internet connection and transmitting data over the Internet or other means of communication (15, 16, 17). The microprocessor gathers data directly from a remote central server (19). This data is converted into appropriate signals to communicate with the pillbox (10). Each pillbox (10) has unique identity information for each person using it including onboard memory such as an EPROM. This identity information is transmitted to the remote central data server (19) to identify the user during every transmission and receipt of data. The pillbox (10) has specific device drivers and onboard data ports to enable connection to the remote central data server (19) via any known transmission protocol such as:

1. TCP/IP

2. LAN/WAN

3. Dial-up connection

4. Wireless/Cell

5. IEEE-488 GPIB

6. RS-422, RS-232

7. Cable Modem and/or xDSL (ADSL/DSL)

8. T1 (1.544 Mbps) Fractional T1—at the server end.

Other means of exporting the data are also considered to be within the scope of the invention. The pillbox (10) is powered by traditional DC sources such as NiCad or Lithium or by AC.

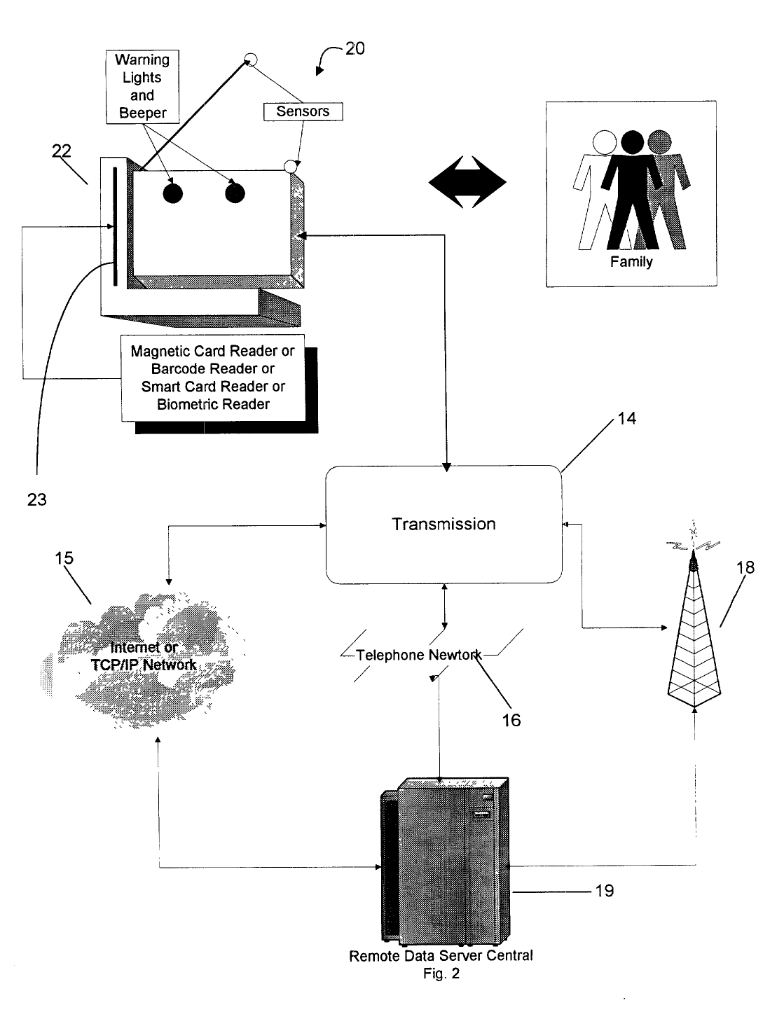

Referring to FIG. 2, in a further embodiment, a cradle (22) is provided for the pillbox (20). A magnetic swipe card reader (23) is used to identify the user and transmit information realtime to the remote central data server (19). The cradle (22) also can have any of the following readers to identify the user of the cradle:

1. Barcode Card Reader

2. Smart Card Reader

3. Biometric Reader such as Fingerprint Scanner, Voiceprint Scanner, Iris Scanner.

Each member of a family of users can utilize one cradle with separate pillboxes because each user will have a unique identification magnetic card assigned to them. The biometric reader can be mounted on the cradle (22) so that the users do not require any additional cards and can operate the pillbox (20) using their finger, voice or iris (as may be required by the biometric reader). The cradle (22) can also have a numeric keypad (not shown) to be used by a user for inputting a pin number to authenticate any transaction for ensuring privacy and security. The cradle (22) has an onboard memory chip to store user authentication information for permanent storage and data from the pillbox (20) for temporary storage and a microprocessor. Alternately, the pillbox (20) can be used remotely to collect data and returned to the cradle wherein the data is then downloaded to the cradle (22) and uploaded to the remote central data server (19).

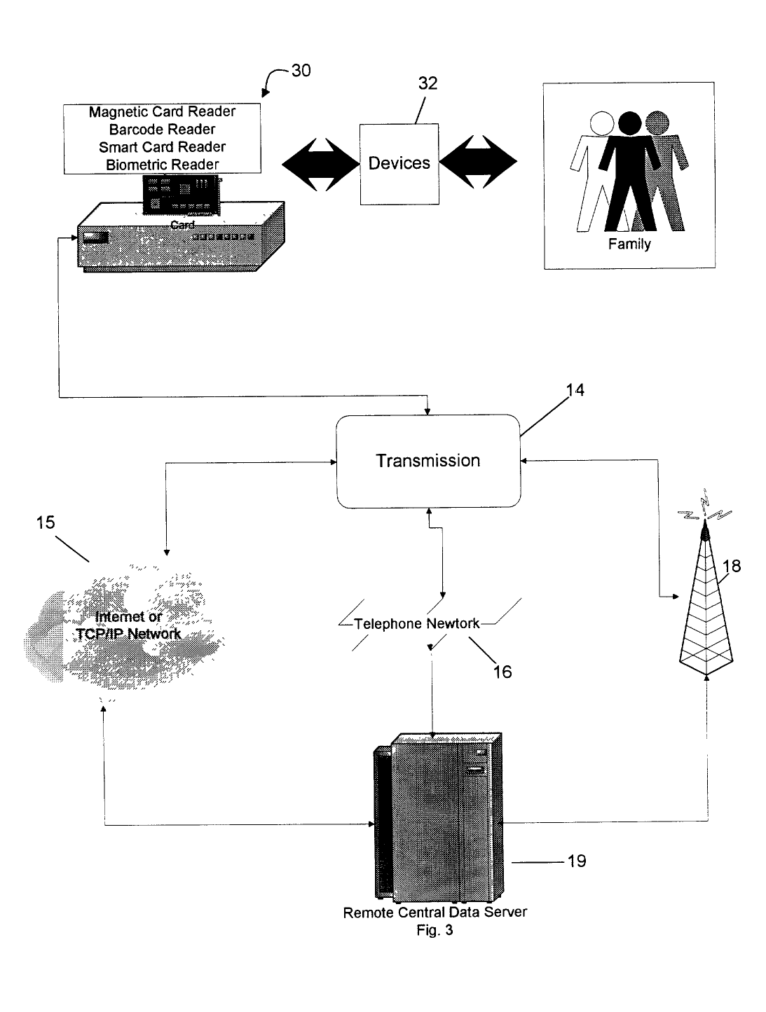

Turning to FIG. 3, another embodiment is depicted. A control box (30) has an onboard microprocessor and device drivers to run specific port communications. A microprocessor uses these device drivers to receive data from external medical devices that are connected to the control box (30) via any/known transmission standard such as: RS-232 Port IEEE-488 GPIB Port RS-422 port Custom Port.

The control box (30) has an onboard memory chip to store data of temporary and permanent nature. The control box (30) also can receive and transmit information to the pillbox as explained in the earlier embodiments. The control box (30) has specific device drivers and onboard ports to transmit the data to the remote central data server (19) via a communication means. Such communications may include, but should not be limited to TCP/IP (Internet); LAN; WAN Wireless/WAP; Dial Up Networking using POTS; and cable modem.

To ensure the integrity of the data being transmitted, the control box (30) includes a means to identify the individual whose data is being transmitted. For example, the control box (30) may include one or more of the following to identify the user of the box for each transmission of data a magnetic swipe card reader; a barcode card reader; a smart card reader; and/or biometric reader such as fingerprint scanner, voiceprint scanner, iris scanner.

Each member of a family of users can use the same control box (30) so long as each has a unique identification means to identify the source of the data being transmitted. A biometric reader envision by the present invention can be mounted on the cradle (22) so that an individual user identity can be determined without an unique card, but solely using their finger, voice or iris (as may be required by the biometric reader). The control box (30) also has a numeric keypad to be used for inputting a pin number to authenticate any transaction for ensuring privacy and security. The control box (30) has an onboard memory chip to store authentication information for permanent storage and data from the pillbox for temporary storage and a microprocessor. This identity information is transmitted to the remote central data server (19) as the data owner identifier during every transmission and receipt of data.

Examples of Medical devices (32) that are applicable for the current embodiment:

A glucometer is a classic medial diagnostic appliance that plays a very crucial role in performing a test away from a healthcare facility mostly at home. The patient has to keep a good record/readings of their sugar levels. It is very important to perform this test at times recommended by an endocrinologist. This control box (30) can be modified to send the readings over the Internet simply by plugging it into a modem or phone jack and pressing a button or by wireless means. The information is sent to the remote central data server (19) and the appropriate action to be taken is determined, such as the taking of pills, injecting insulin or calling the physician, all of which depend on the reading.

A blood pressure apparatus is another example of a self-administered test where the present invention can help in data collection, documentation as well as compliance monitoring.

An electronic treadmill with an Internet connection can very effectively be used to track its usage and monitor readings such as a person's pulse and heart rate. Similarly, the application can be extended to blood analyzers urine analyzers, stool analyzers, x-ray equipment, EKG machines, fat analyzers and office visit trackers.

Using the present invention, patients and caregivers or other interested party, can set up different levels of monitoring. The remote central data server is designed to receive data from the following sources or modes: smart pillboxes, control boxes, direct web based entry, direct database entry, PDA's (Personal Digital Assistants), portable computers, IVR (interactive voice response system) using POTs or cellular, pagers, e-mails or faxes. Therefore, patients and caregivers can set up specific trigger levels that occur upon the happening or nonoccurrence of an event.

Depending on the type of data, patient triggers are set based upon: 1) presence of data; 2) absence of data; 3) values of data; and 4) values of trigger limits. These triggers could be of many types which include: medication reminders, prescription pickup reminders, refill reminders, home health test reminders, data collection reminders or emergency alerts. These triggers could be delivered to the following person or entity depending on the member's authorization: the member, the member's guardian or family member, the member's affinity circle, the member's doctor or to 911. The triggers can be delivered via: phone, cellular, e-mail, pager, fax, smart-pillbox or control box. The data is collected and resides on the remote central data servers and can be retrieved by the member or any person authorized by the member by the following methods: Internet, phone, fax or e-mail.

Additionally, it should be noted that rather than only utilizing the contacts for collecting data, any other means for collecting data can be utilized. The present invention also provides business to business applications including applications that connect health care professionals and businesses with other health care professionals and businesses. For example, a pharmacy communicates patient data information with the doctor via a customized personalized digital assistants. Also, business to consumer applications that connect consumers with healthcare professionals and businesses. For example a consumer gets a reminder from the doctor about the check-up due in a week or the patient relays the blood pressure results for past week to the doctor.

Encryption and Security can be provided through various technologies including: authentication through Secure ID, (allow Login after user password authentication); H/W device that encrypts data; or readily available standard encryption schemes such as 128-bit encryption schemes using public key encryption protocols and the associated user certificates (SSL-ready).

This invention relates to a method and apparatus for collecting healthcare data from individuals or patients without the requirement of the user taking any action to assist in the collection thereof. While this invention has been described with specific embodiments, many alternatives, modifications and variations will be apparent to those skilled in the art in light of the foregoing description. Accordingly, it is intended to include all such alternatives, modifications and variations set forth within the spirit and scope of the description.

What is claimed is:

1. A method for acquiring data related to a person's healthcare habits comprising the steps of:
(a) setting data trigger types and values;
(b) collecting data from a device;
(c) monitoring data trigger values;
(d) setting data owner identifiers;
(e) transmitting the data and data owner identifiers electronically to a remote central location for processing; and
(f) providing access to the data from various other remote locations over the Internet or other network.

2. The method of claim 1 wherein collecting data includes collecting data from dumb devices that have no electronics or computing power.

3. The method of claim 1 wherein collecting data includes collecting data automatically from devices that have computing power and associated electronics.

4. The method of claim 1 wherein the data is transmitted via the Internet or telephonically.

5. The method of claim 1 wherein the trigger values are selected from the group comprising the presence of data, the absence of data, the value of the data and the value of the trigger limit.

6. The method of claim 1 wherein the trigger types are selected from the group comprising medication reminder, prescription pick-up reminder, refill reminder, home test reminder, data collection reminder or emergency alerts.

7. A device for acquiring data related to a person's healthcare habits comprising:
(a) a module adapted to be opened and closed;
(b) at least two sensors connected to the module;
(c) indicating means connected to the module;
(d) a memory for storing data connected to the first module; and
(e) means for transmitting the data from the module to a remote central location.

8. The device of claim 7 wherein the memory stores data related to the opening and closing of the first module.

9. The device of claim 7 wherein the data is transmitted via the Internet or telephonically.

10. The device of claim 7 wherein the indicating means comprises at least one indicating light.

11. The device of claim 7 wherein the indicating means comprises at least one sound emitting means.

12. The device of claim 7 further comprising:
a second module adapted to receive the first module;
a device for accessing the second module;
means for transmitting the data from the first module to the second module; and
means for transmitting the data from the second module to a remote central location.

13. The device of claim 7 wherein the device for accessing the second module is selected from the group comprising a magnetic card reader, a barcode reader, a smart card reader or a biometric reader.

14. A device for acquiring data related to a person's healthcare habits comprising:
a first module adapted to receive a second module;
a memory for storing data connected to the first module;
a second module adapted to receive the first module;
an identification device capable of being used with the first module;
means for transmitting the data from the second module to the first module; and
means for transmitting the data from the first module to a remote central location.

15. The device of claim 14 wherein the identification device is selected from the group comprising a magnetic card reader, a barcode reader, a smart card reader or a biometric reader.

16. The device of claim 14 wherein the second module is selected from the group comprising a treadmill, a glucometer or a blood pressure apparatus.

17. The device of claim 14 wherein the second module is selected from the group comprising a stool analyzer, an Xray machine, an EKG machine, a fat analyzer or an office visit tracker.
